(19) United States
(12) Patent Application Publication
(10) Pub. No.: US 2026/0251131 A1
(43) Pub. Date: Aug. 27, 2026

(54) Rotational Actuator Systems With Shape Memory Alloy Actuators

(71) Applicant: Hutchinson Technology Incorporated, Hutchinson, MN (US)

(72) Inventors: Erich W. Bierbrauer, Hutchinson, MN (US); Richard A. Schnitzler, Dassel, MN (US)

(21) Appl. No.: 19/544,847

(22) Filed: Feb. 19, 2026

Related U.S. Application Data
(60) Provisional application No. 63/762,495, filed on Feb. 24, 2025.

(51) Int. Cl. F03G 7/06

(52) U.S. Cl. CPC F03G 7/06143

(57) ABSTRACT

The present embodiments relate to a rotational actuator using a set of shape memory alloy (SMA) actuators to cause rotational motion of an actuator body. The actuator body can include a fixed portion configured to remain static and a moving portion configured to rotate. A set of shape memory alloy (SMA) actuators can be connected to the actuator body. Each SMA actuator can include a fixed end fixed to the fixed portion of the actuator body and a free end in contact to the moving portion. Each SMA actuator can include a SMA material disposed between the fixed end and the free end. Each SMA actuator can, in response to an electrical current, extend or retract to enable rotation of the moving portion in a clockwise or a counter-clockwise direction.

### CROSS-REFERENCE TO RELATED APPLICATION(S)

The present application claims priority to U.S. Provisional Patent Application No. 63/762,495, titled “ROTATIONAL ACTUATOR SYSTEMS WITH SHAPE MEMORY ALLOY ACTUATORS,” and filed Feb. 24, 2025, the entirety of which is incorporated by reference in its entirety herein.

### FIELD

The invention relates generally to an actuator, and more particularly, to a rotational actuator with a set of shape memory alloy actuators to cause rotational movement of the rotational actuator.

### BACKGROUND

An actuator can be used in a variety of contexts. For example, an actuator can move a mass with a center of rotation. The actuator can move in response to an electrical current being applied to the actuator. In many cases, it can be desirable to move a moving component in a desired direction (e.g., a rotation).

However, many actuator designs may cause movement of the moving component in directions other than the desired direction (e.g., pitch, yaw, roll). For example, an actuator can be designed to move in a z-direction but, upon actuation, the actuator can move in the y-direction. Such adverse motions can cause stress in the actuator, as these forces can add unwanted torque and out of plane bending forces on the actuator. Therefore, it is desirable for an actuator with a design that constrains unwanted movement (e.g., pitch, yaw, tilt) during rotation of a payload.

### SUMMARY

The present embodiments relate to a rotational actuator using a set of shape memory alloy (SMA) actuators to cause rotational motion of an actuator body. The actuator body can include a fixed portion configured to remain static and a moving portion configured to rotate. A set of shape memory alloy (SMA) actuators can be connected to the actuator body. Each SMA actuator can include a fixed end fixed to the fixed portion of the actuator body and a free end in contact to the moving portion. Each SMA actuator can include a SMA material disposed between the fixed end and the free end. Each SMA actuator can, in response to an electrical current, extend or retract to enable rotation of the moving portion in a clockwise or a counter-clockwise direction.

In a first example embodiment, a rotational actuation system is provided. The rotational actuation system can include an actuator body that comprises a fixed portion configured to remain static and a moving portion configured to rotate. The rotational actuation system can also include a rod disposed in an opening formed the actuator body along a central axis.

The rotational actuation system can also include a set of shape memory alloy (SMA) actuators. Each SMA actuator can include a fixed end fixed to the fixed portion of the actuator body and a free end in contact to the moving portion. Each SMA actuator can also include a shape memory alloy (SMA) material disposed between the fixed end and the free end. Each of the set of SMA actuators can be configured to, in response to an electrical current, extend or retract to enable rotation of the moving portion in a clockwise or a counter-clockwise direction.

In some instances, rotational actuation system further includes a low friction centering element disposed adjacent to the rod, wherein the low friction centering element includes any of a bearing, a bushing, opposite poled magnets, and a flexure spring.

In some instances, the set of SMA actuators include a first pair of SMA actuators disposed on a first side of the actuator body.

In some instances, the set of SMA actuators include a second pair of SMA actuators disposed on a second side of the actuator body opposite the first side.

In some instances, the electrical current is configured to be provided to a first SMA actuator of the first pair of SMA actuators and a first SMA actuator of the second pair of SMA actuators to cause clockwise or counter-clockwise rotation of the moving portion.

In some instances, any of the set of SMA actuators are disposed in a vertical orientation where a length of each SMA actuator is disposed substantially in parallel with the central axis.

In some instances, the moving portion is disposed above the fixed portion of the actuator body in the vertical orientation.

In some instances, any of the set of SMA actuators are disposed in a horizontal orientation where a length of each SMA actuator is disposed substantially perpendicular to the central axis.

In some instances, the SMA material for each of the set of SMA actuators is connected at a first end to the fixed end of the SMA actuator and connected at a second end to the free end of the SMA actuator.

In some instances, the moving portion is configured to move around 20 degrees in either the clockwise or the counter-clockwise direction.

In some instances, the rotational actuation system further includes a housing formed in the fixed portion configured to house a fluid.

In some instances, the fluid is configured to be hermetically sealed in the housing, and wherein the fluid comprises any of a water/glycol mixture or a mineral oil to cool the rotational actuator.

In some instances, the rotational actuation system further includes any of a return spring, one or more coupled rotary devices, a position sensing system, and a position control system.

In some instances, a string is configured to connect between the free end of any of the set of SMA actuators and the moving portion.

In some instances, the moving portion comprises a spur gear, wherein the rod is disposed in a center of the spur gear, and wherein movement of the spur gear allows each SMA actuator to return to a starting position before any tooth of the spur gear moves past the free end the SMA actuators.

In another example embodiment, a device is provided. The device can include an actuator body that comprises a fixed portion configured to remain static and a moving portion configured to rotate. The device can also include a set of shape memory alloy (SMA) actuators that each include a fixed end fixed to the fixed portion of the actuator body and a free end in contact to the moving portion. Each SMA actuator can also include a shape memory alloy (SMA) material disposed between the fixed end and the free end. Each of the set of SMA actuators can be configured to, in response to an electrical current, extend or retract to enable rotation of the moving portion in a clockwise or a counter-clockwise direction.

In some instances, the device can include a rod disposed in an opening formed the actuator body along a central axis.

In some instances, the device can include a low friction centering element disposed adjacent to the rod, wherein the low friction centering element includes any of a bearing, a bushing, opposite poled magnets, and a flexure spring.

In some instances, the set of SMA actuators include a first pair of SMA actuators disposed on a first side of the actuator body and a second pair of SMA actuators disposed on a second side of the actuator body opposite the first side.

In some instances, any of the set of SMA actuators are disposed in a vertical orientation where a length of each SMA actuator is disposed substantially in parallel with the central axis or are disposed in a horizontal orientation where a length of each SMA actuator is disposed substantially perpendicular to the central axis.

Other features and advantages of embodiments of the present invention will be apparent from the accompanying drawings and from the detailed description that follows.

### BRIEF DESCRIPTION OF THE DRAWINGS

Embodiments of the present invention are illustrated, by way of example and not limitation, in the figures of the accompanying drawings, in which like references indicate similar elements and in which:

FIGS. 1A-1C illustrates views of prior art SMA actuators according to some embodiments.

FIGS. 2A-2B illustrate views of an example rotational actuator in a vertical configuration according to some embodiments.

FIGS. 3A-3B illustrate top views of an example rotational actuator in a vertical configuration according to some embodiments.

FIGS. 4A-4B illustrate views of an example rotational actuator in a horizontal configuration according to some embodiments.

FIGS. 5A-5B illustrate top views of an example rotational actuator in a horizontal configuration according to some embodiments.

FIGS. 6A-6B illustrate views of an example rotational actuator according to some embodiments.

FIG. 7 illustrates an example actuator with a bathtub to house a fluid according to some embodiments.

FIG. 8 illustrates a top view of an example system in various states of actuation according to some embodiments.

FIGS. 9A-9C illustrate side views of an example system including an actuator with a string or wire disposed around a bearing according to some embodiments.

FIGS. 10A-10D illustrates a system for rotating a spur gear using a set of actuators according to some embodiments.

FIG. 11 illustrates an example system with multiple actuators connected to a gear according to some embodiments.

### DETAILED DESCRIPTION

Rotational actuators can include mechanical or electromechanical devices that produce controlled rotational motion, converting various forms of energy into angular displacement. These actuators can be used in a variety of applications to provide fine rotational motion. Unlike linear actuators that move in a straight line, rotational actuators can create turning or spinning motion around a fixed axis. These devices can operate within different mechanisms including electric motors, pneumatic cylinders, hydraulic systems, or piezoelectric elements, depending on the application requirements and the torque and speed needed.

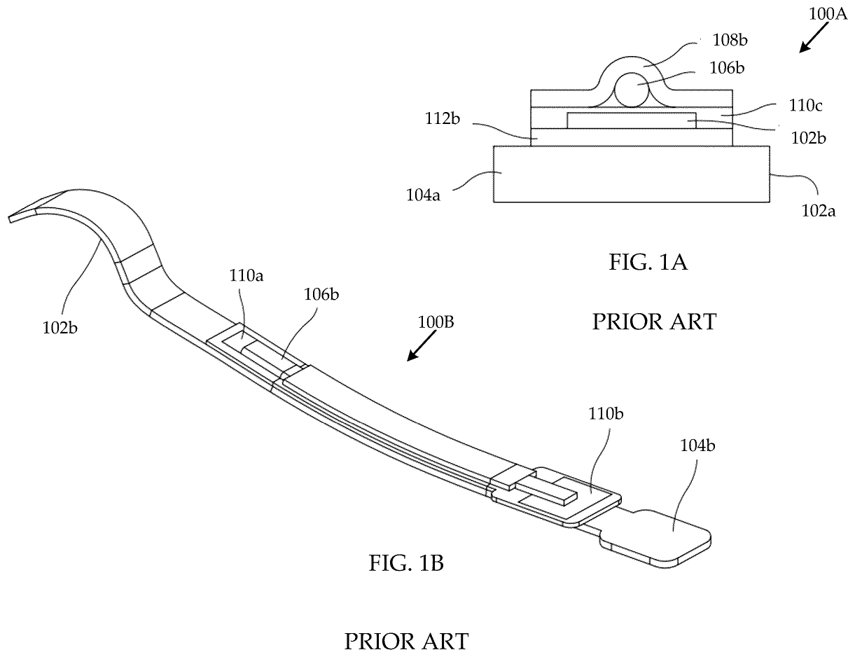

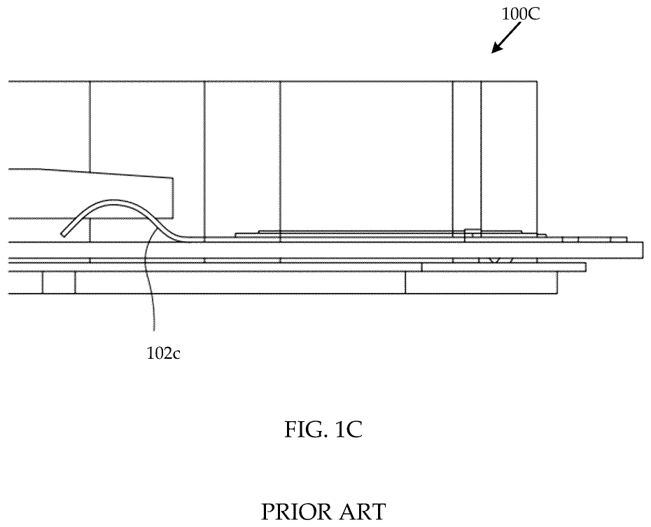

A shape metal alloy (SMA) actuator can be used as an actuator in various actuation systems. FIGS. 1A-1C illustrate views of prior art SMA actuators according to some embodiments. According to various embodiments, a SMA actuator 102a-c includes a beam 104a-b and one or more SMA materials 106 such as an SMA ribbon 106b (e.g., as illustrated in a perspective view of a SMA actuator including an SMA ribbon according to the embodiment of FIG. 1B) or SMA wire 106b (e.g., as illustrated in a cross-section of a SMA actuator including an SMA wire according to the embodiment of FIG. 1A). The SMA material 106b is affixed to the beam 104a-b using techniques including those described herein. According to some embodiments, the SMA material 106b is affixed to a beam 104a-b using adhesive film material 108. Ends of the SMA material 106b, for various embodiments, are electrically and mechanically coupled with contacts 110a-c configured to supply current to the SMA material 106b using techniques including those known in the art. The contacts 110a-c (e.g., as illustrated in FIGS. 1A and 1B), according to various embodiments, are gold plated copper pads.

According to embodiments, a SMA actuator 102a-c having a length of approximately 1 millimeter are configured to generate a large stroke and push forces as part of a lens assembly, for example as illustrated in FIG. 1C. For an embodiment, a SMA actuator 102a-c includes a SMA material 106b, an insulator 112a-b, such as a polyimide insulator, and a stainless steel beam 104a-b or base metal. Various embodiments include a second insulator 114 disposed between a contact layer including the contacts 110a-c and the SMA material 106b. The second insulator 114 can be configured, according to some embodiments, to insulate the SMA material 106b from portions of the contact layer not used as the contacts 110a-c. For some embodiments, the second insulator 114 is a covercoat layer, such a polyimide insulator. One skilled in the art would understand that other dimensions and materials could be used to meet desired design characteristics.

Further, rotational actuators can be used in a variety of contexts. For example, actuators can be used in automation applications to precisely position components in different systems. However, in many instances, actuator designs may cause movement of the moving component in directions other than the desired direction (e.g., pitch, yaw, roll). For example, an actuator can be designed to move in a z-direction but, upon actuation, the actuator can move in the y-direction. Such adverse motions can cause stress in the actuator, as these forces can add unwanted torque and out of plane bending forces on the actuator. Therefore, it is desirable for an actuator with a design that constrains unwanted movement (e.g., pitch, yaw, tilt) during rotation of a payload.

The present embodiments relate to a rotational actuation system using a set of shape memory alloy (SMA) actuators to cause rotational motion of an actuator body. The actuation system can include a rod (or dowel) disposed along a central axis of the actuation system with a low friction centering (e.g., bearing, bushing, opposite poled magnets, flexure spring) to ensure smooth movement of the actuators. The SMA actuators can have a fixed end that is fixed to a static part of the actuator body and a free end configured to contact a moving part of the actuator body. Further, the positioning of opposing actuators can actuate to cause rotational movement of the moving part relative to a central axis.

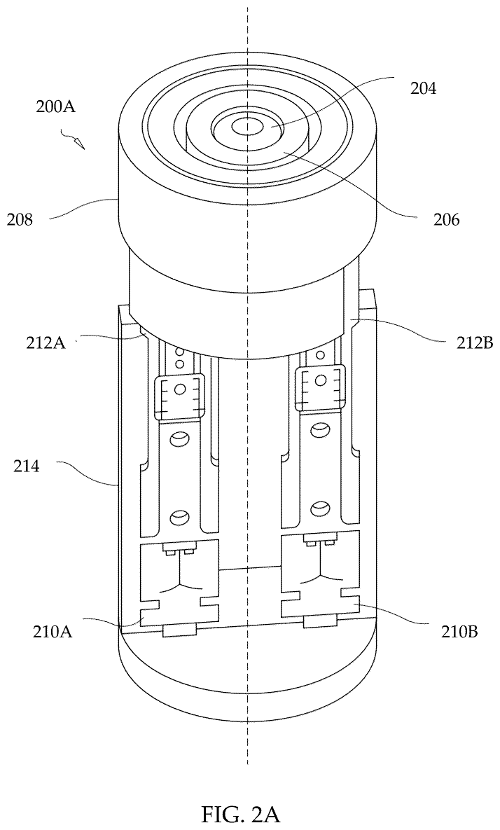

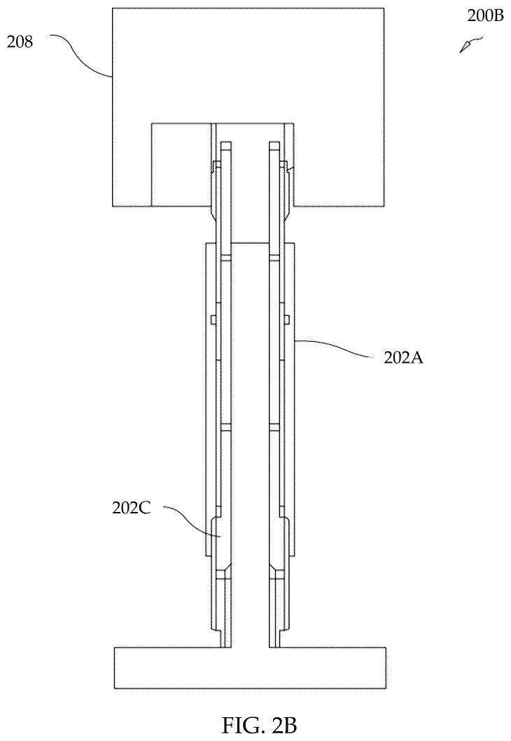

For example, a rotational actuation system (e.g., as shown in FIGS. 2A-2B) can have multiple actuators mounted to a static element of the system. A free end of each actuator can be directed toward (or connected to) a moving element of the system. Upon a current being applied to any of the actuators, the moving element of the system can rotate. For example, four actuators can be disposed about the moving element, and opposing actuators can actuate, causing the rotational movement of the moving element in a desired direction.

FIGS. 2A-2B illustrate views of a rotational actuator 200A-B in a vertical configuration. The rotational actuator 200A-B can include multiple actuators (e.g., 202A-C) disposed adjacent to a dowel 204 that can cause rotation of a moving element 208. The actuators 202A-C can, in response to a current being provided to any of the actuators 202A-C, actuate and cause rotation of the moving element 208 in a desired direction.

As shown in FIG. 2A, the rotational actuator 200A can include a dowel (or rod) 204 disposed along a central axis P1 of the rotational actuator 200A. Further, a bearing 206 can be disposed adjacent to the dowel. While a bearing is described, any low friction centering component, such as a bushing, opposite poled magnets, flexure spring, etc., can be disposed adjacent to dowel 204 to reduce friction of the dowel 204 and moving element 208 during rotation.

The rotational actuator 200A can further include a number of actuators 202A-C. The actuators 202A-C can include shape memory alloy (SMA) actuators that include a SMA element that actuates in response to an electrical current being applied to the SMA element. The SMA actuators 202A-C can be disposed adjacent to the dowel 204.

Each SMA actuator 202A-C can include a fixed end 210A, 210B fixed to the actuator base 214. Further, the SMA actuators 202A-C can include a free end 212A, 212B that is disposed adjacent to (or connected to) moving element 208. An SMA element (not shown) can extend from fixed end 210A-B to free end 212A-B to cause actuation of the free end 212A-B.

FIG. 2B illustrates a side view of the rotational actuator 200B. In FIG. 2B, the side view can show SMA actuators 202A, 202C in an opposing configuration. In an example embodiment, two actuators (e.g., 202A, 202B) can be disposed on each side of the base 214, with actuators opposing one another (e.g., opposing actuators 202A, 202C). Electrical currents can be provided to specific actuators 202A-C to cause rotation of the moving element 208.

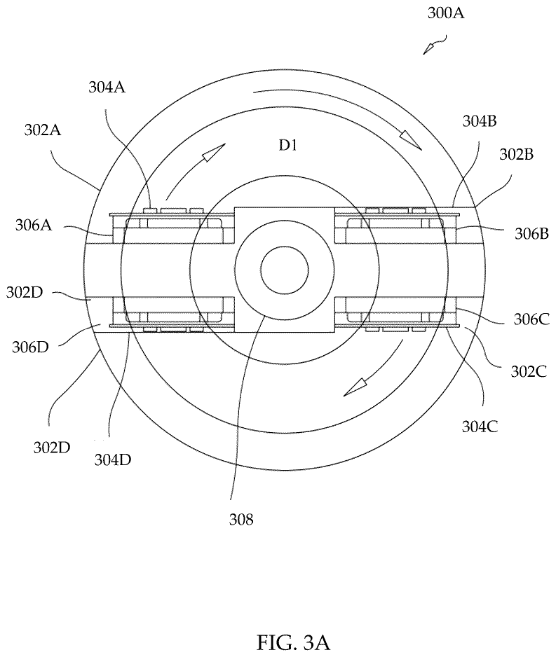

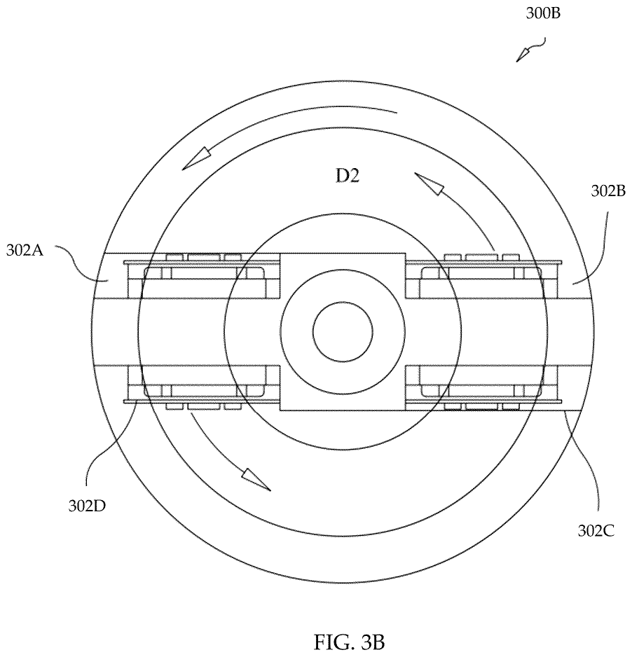

FIGS. 3A-3B illustrate top views of a rotational actuator 300A-B in a vertical configuration. In FIGS. 3A-3B, a top view of the rotational actuator 300A-B depicts a number of actuators 304A-D disposed opposite to one another and disposed adjacent to dowel 308. Each actuator 302A-B can include a base portion 306A-D supporting a beam 304A-D. The SMA elements for each actuator 302A, 302B, 302C, 302D can be disposed on beam 304A, 304B, 304C, 304D.

Further, in FIG. 3A, a first view 300A of the rotational actuator in a vertical configuration can include SMA actuators 302A-D in a vertical configuration to allow clockwise motion in direction D1. The upper left (e.g., 302A) and lower right (e.g., 302C) actuators can extend simultaneously while the upper right (e.g., 302B) and lower left (e.g., 302D) actuators can retract, thus rotating the top clockwise.

FIG. 3B is a second view 300B of the rotational actuator in a vertical configuration can include SMA actuators 302A-D in a vertical configuration to allow counter-clockwise motion in direction D2. The upper right (e.g., 302B) and lower left (e.g., 302D) actuators can extend simultaneously the upper left (e.g., 302A) and lower right (e.g., 302C) actuators can retract, thus rotating the top counterclockwise.

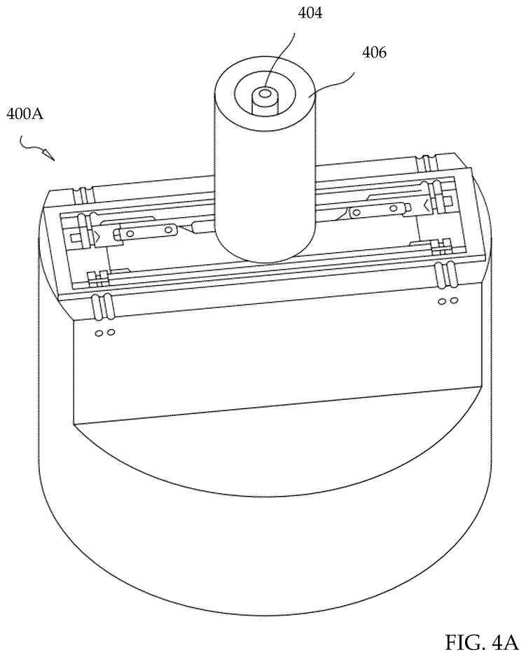

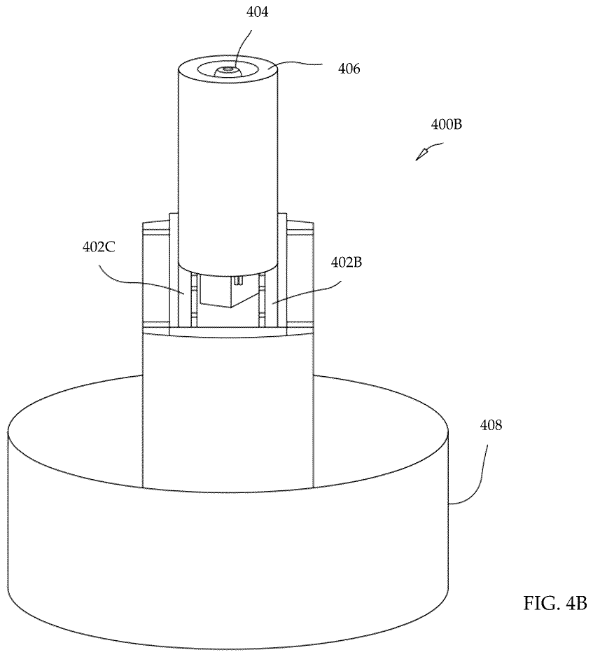

FIGS. 4A-4B illustrate views 400A, 400B of a rotational actuator in a horizontal configuration. As shown in FIG. 4A, the actuator 400A can include four SMA actuators 402A, 402B, 402C, 402D. Actuators 402A-D can be connected to base 408 and disposed horizontally such that the length of each actuator 402A-D is perpendicular to the dowel 404 that is surrounded by the moving element 406.

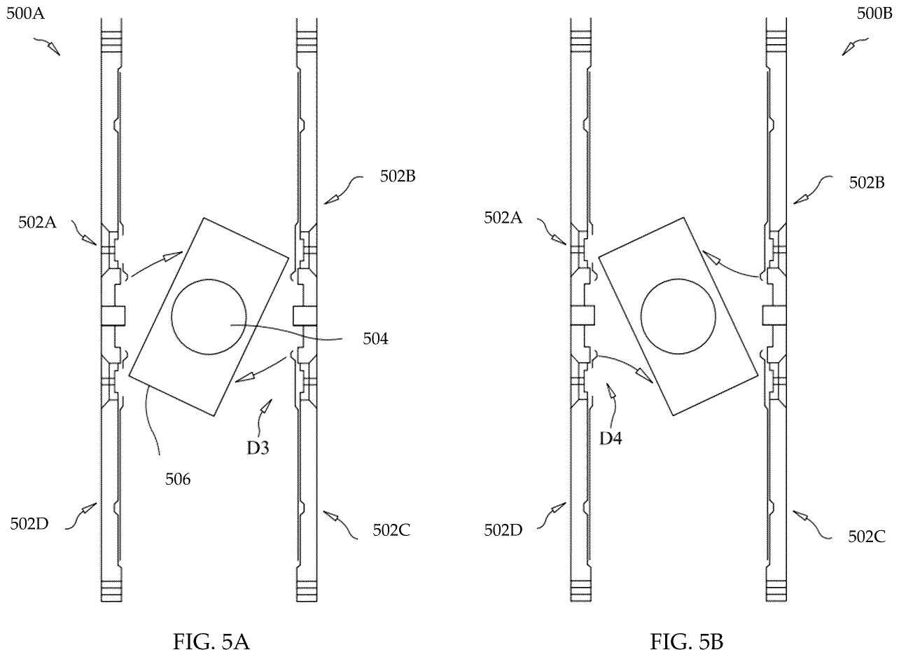

FIGS. 5A-5B illustrate top views of a rotational actuator 500A-B in a horizontal configuration. In FIGS. 5A-5B, a top view of the rotational actuator 500A-B can show actuators 502A-D in a horizontal configuration facing moving element 506 and dowel 504.

Further, in FIG. 5A, a first view 500A of the rotational actuator in a horizontal configuration can show actuators 502A-D configured to rotate a moving element 506 in a clockwise direction D3. The upper left (e.g., 502A) and lower right (e.g., 502C) actuators can extend simultaneously, while the upper right (e.g., 502B) and lower left (e.g., 502D) actuators retract, thus rotating the top clockwise.

FIG. 5B illustrates a view 500B of the rotational actuator in a horizontal configuration with actuators 502A-D configured to rotate a moving element 506 in a counter-clockwise direction D4. The upper right (e.g., 502B) and lower left (e.g., 502D) actuators can extend simultaneously the upper left (e.g., 502A) and lower right (e.g., 502C) actuators can retract, thus rotating the top counterclockwise.

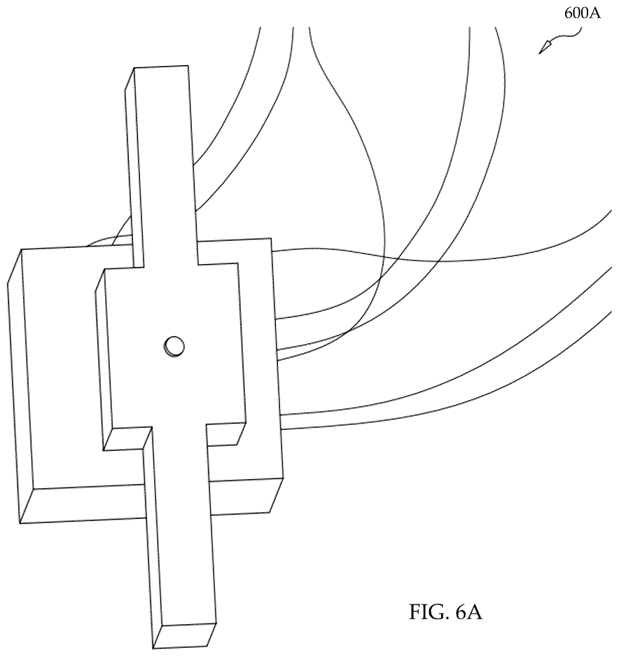

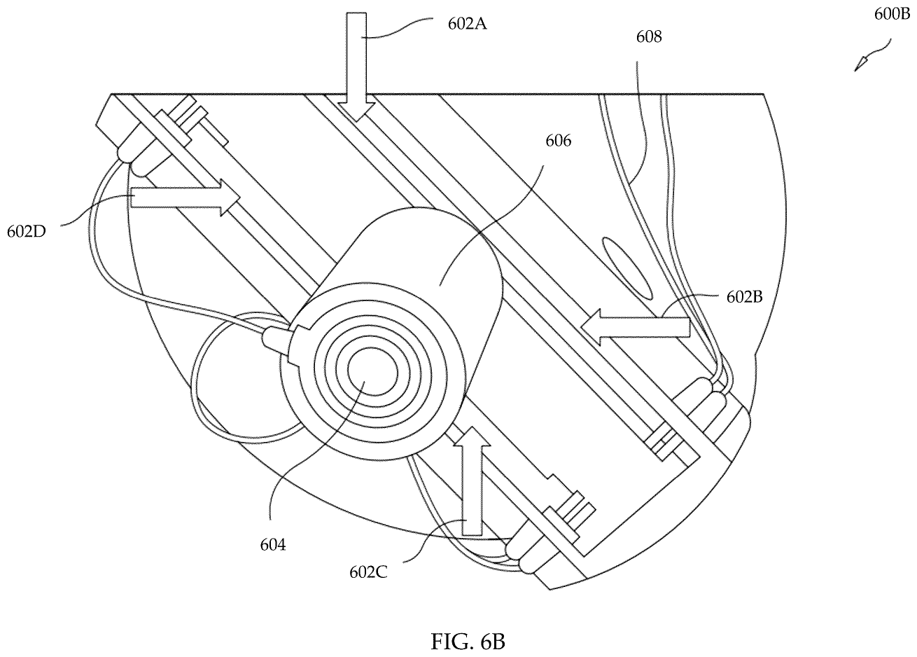

FIGS. 6A-6B illustrate views of an example rotational actuator prototype 600A, 600BB. The prototype as shown in FIGS. 6A-6B can show four SMA actuators 602A-D. Actuators 602A-D can have a fixed end fixed to base 608 with a free end contacting the moving element 606 that surrounds the dowel 604.

Further, the prototypes can allow for ±20° rotation, 1.67 Hz in air, with a ~50 mg mass. Another test can include determining the frequency with actuators submerged in anti-freeze @ ±20° rotation with a 50 mg mass. Pairs of SMA actuators can be powered at the same time to create desired motion.

Many different variations to the actuator design can be provided. For instance, a fluid can be added to the actuator and hermetically seal fluid (water/glycol, mineral oil, etc.) to assist in cooling the wire thus a faster response actuator for higher speed rotation. This can quicken a nitinol device.

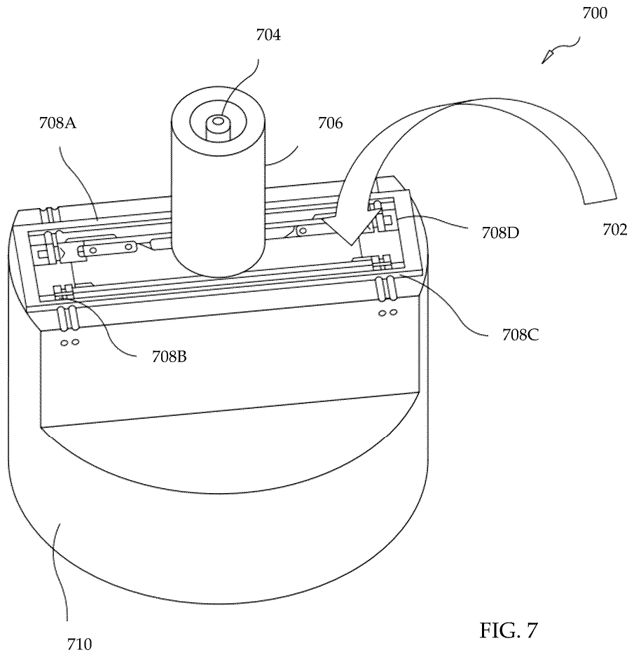

FIG. 7 is an example rotational actuator 700 with a housing (e.g., bathtub 702) to house a fluid. As shown in FIG. 7, the rotational actuator 700 can include actuators 708A-B in a horizontal configuration relative to the dowel 704 and the moving element 706. A bathtub 602 can include a recess or opening formed in the base 710 that can house a fluid. The bathtub 702 can include a top or lid that can hermetically seal the fluid (water/glycol, mineral oil, etc.).

Another example design variation can include adding a return mechanism (torsion spring, cantilever spring, silicone to movable section so it returns to center on its own. Any design variation can be used to actuate a rotary device. Further, a variable number of wires, SMA actuators, diameters to increase/decrease force, increase/decrease rotation, and increase/decrease speed can be provided. In some instances, multiple rotary devices can be coupled, position sensing using SMA actuators, and/or position control techniques can be implemented.

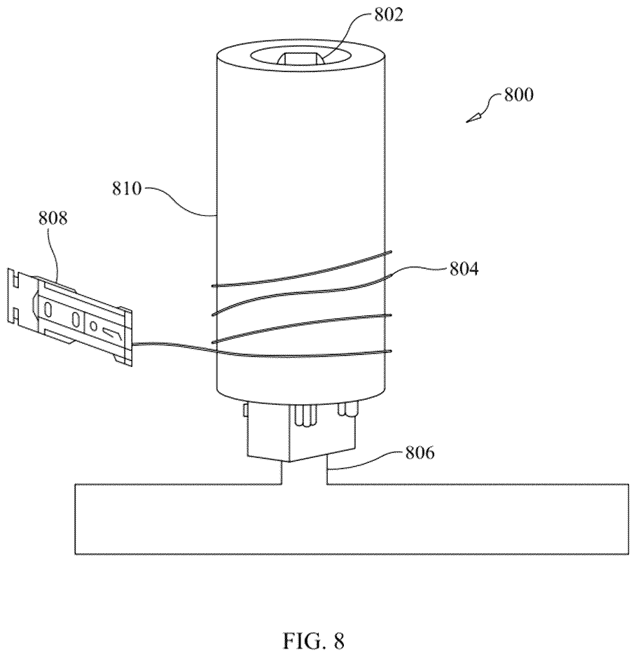

FIG. 8 illustrates a top view of a system in various states 800A-C of actuation. For example, in a zero state 800A, the actuator 802 is in an unactuated state, with the string 804 connecting the actuator 802 and moving element 806. Further, in an actuated state 800B, the free end 808 of the actuator 802 is actuated, causing tension to the string 804 and causing rotation of the moving element 806. In a returned to zero state 800C, the actuator 802 is returned to the unactuated state, with the tension in the string 804 being lowered and the moving element 806 being rotated to the original state.

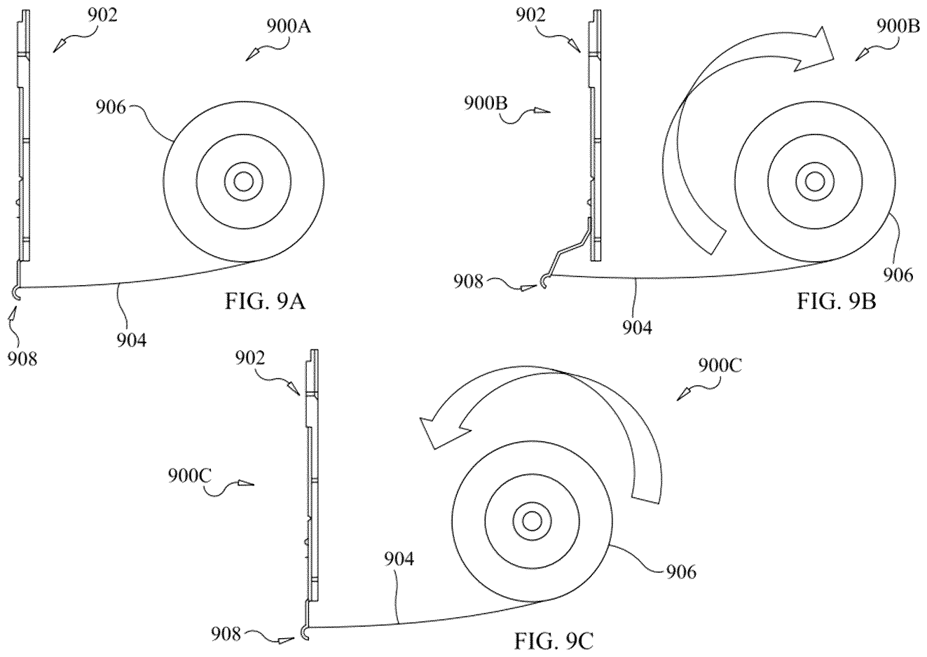

In some embodiments, a single actuator can be used with a torsion spring return using a string. FIGS. 9A-9C illustrate side views of an example system 900A-C including an actuator with a string or wire disposed around a bearing. As shown in FIGS. 9A-9C, a bearing 902 can be affixed to a torsion spring return 906. The bearing 902 can also include a bushing or a similar component. Further, the torsion spring return 906 can be silicone or another suitable material, and can be used to return motion of the bearing 902 back to a starting point.

Further, in FIGS. 9A-9C, an actuator 908 can have a string or wire 904 attached to a free end of the actuator 906. The string or wire 904 can be connected to or wrapped around the bearing 902 and/or the moving element 910. The string or wire 904 can assist in rotating the moving element 910 by providing tension or torque to the moving element 910 to cause rotation of the moving element 910.

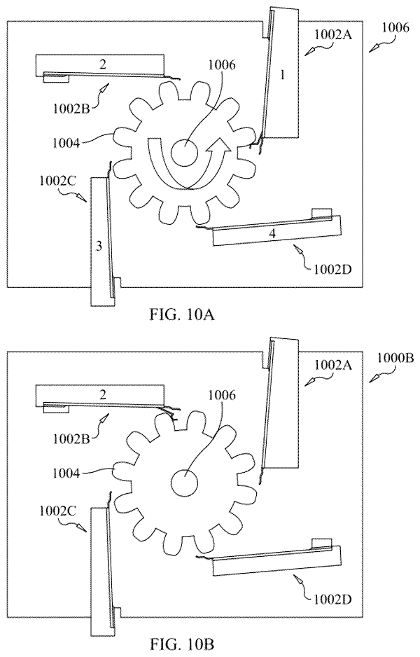

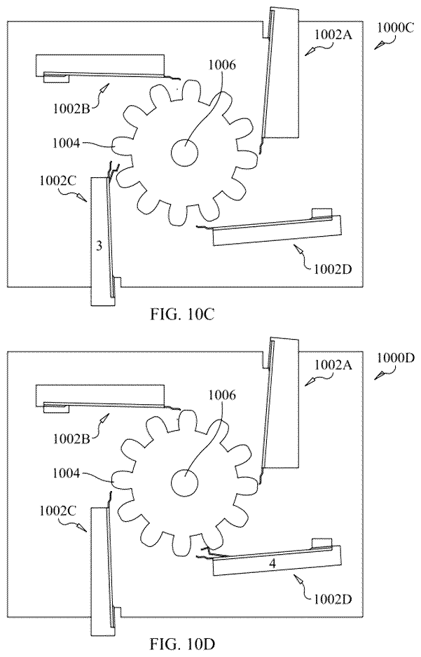

In another example embodiment, the moving element can include a gear or a spur gear. FIGS. 10A-10D illustrate an example rotational actuator 1000A-D that includes a spur gear. As shown in FIG. 10A, a spur gear 1004 can be disposed adjacent to a series of actuators 1002A-D. A dowel or rod 1006 can be disposed in a center of the gear 1004, where the dowel or rod 1006 can include a bearing, bushing, or opposite magnets, for example. A first actuator 1002A can actuate and push the gear 1004 in rotation of a small amount (e.g., ¼ distance between spurs) and then can return to the starting position.

In FIG. 10B, a second actuator 1002B can actuate and push the gear 1004 in rotation of a small amount (e.g., ¼ distance between spurs) and then can return to the starting position. Similarly, in FIG. 10C, a second actuator 1002C can actuate and push the gear 1004 in rotation of a small amount (e.g., ¼ distance between spurs) and then can return to the starting position. In FIG. 10D, a second actuator 1002D can actuate and push the gear 1004 in rotation of a small amount (e.g., ¼ distance between spurs) and then can return to the starting position.

In some embodiments, multiple gears can be stacked on one another. For example, one or more additional gears can be stacked over gear 1004, with four actuators connected to each gear. The actuators can be orientated so one set of actuators make the gear go counterclockwise and the other set makes the other gear go clockwise.

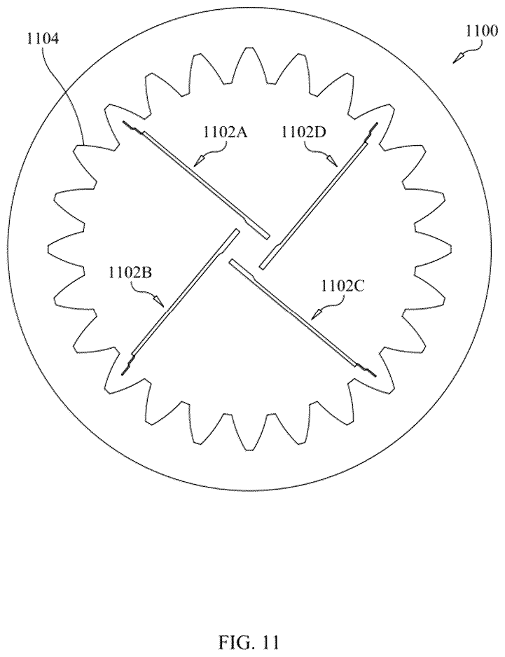

FIG. 11 illustrates an example system 1100 with multiple actuators connected to a gear. As shown in FIG. 11, a gear 1104 can be connected to a set of actuators 1102A-D. The actuators can be positioned on an inside of the gear or, in some cases, on the outside of the gear as well. The actuators can be positioned at any angle relative to the gear.

In some instances, each actuator can connect to a power source via one or more connectors. For instance, a set of wires can connect each actuator to the power source configured to provide the current to the actuator. Leads or wires can connect to the fixed element of the actuator via a suitable technique (e.g., adhesive, solder, resistance weld) to connect the leads to the actuator. In another example, the actuator can be electrically connected to the static element such that an electrical current is provided between the static portion and the actuators. The electrical current can further be provided to the actuators selectively to drive rotational motion of the moving element.

In a first example embodiment, a rotational actuation system is provided. The rotational actuation system can include an actuator body that comprises a fixed portion configured to remain static and a moving portion configured to rotate. The rotational actuation system can also include a rod disposed in an opening formed the actuator body along a central axis.

The rotational actuation system can also include a set of shape memory alloy (SMA) actuators. Each SMA actuator can include a fixed end fixed to the fixed portion of the actuator body and a free end in contact to the moving portion. Each SMA actuator can also include a shape memory alloy (SMA) material disposed between the fixed end and the free end. Each of the set of SMA actuators can be configured to, in response to an electrical current, extend or retract to enable rotation of the moving portion in a clockwise or a counter-clockwise direction.

In some instances, rotational actuation system further includes a low friction centering element disposed adjacent to the rod, wherein the low friction centering element includes any of a bearing, a bushing, opposite poled magnets, and a flexure spring.

In some instances, the set of SMA actuators include a first pair of SMA actuators disposed on a first side of the actuator body.

In some instances, the set of SMA actuators include a second pair of SMA actuators disposed on a second side of the actuator body opposite the first side.

In some instances, the electrical current is configured to be provided to a first SMA actuator of the first pair of SMA actuators and a first SMA actuator of the second pair of SMA actuators to cause clockwise or counter-clockwise rotation of the moving portion.

In some instances, any of the set of SMA actuators are disposed in a vertical orientation where a length of each SMA actuator is disposed substantially in parallel with the central axis.

In some instances, the moving portion is disposed above the fixed portion of the actuator body in the vertical orientation.

In some instances, any of the set of SMA actuators are disposed in a horizontal orientation where a length of each SMA actuator is disposed substantially perpendicular to the central axis.

In some instances, the SMA material for each of the set of SMA actuators is connected at a first end to the fixed end of the SMA actuator and connected at a second end to the free end of the SMA actuator. The SMA material can be connected to the actuator via any of an adhesive, a resistance weld, solder, etc.

In some instances, the moving portion is configured to move around 20 degrees in either the clockwise or the counter-clockwise direction.

In some instances, the rotational actuation system further includes a housing formed in the fixed portion configured to house a fluid.

In some instances, the fluid is configured to be hermetically sealed in the housing, and wherein the fluid comprises any of a water/glycol mixture or a mineral oil to cool the rotational actuator.

In some instances, the rotational actuation system further includes any of a return spring, one or more coupled rotary devices, a position sensing system, and a position control system. The torsion return spring can provide torque that returns rotational motion of the moving portion back to a starting point.

In some instances, a string is configured to connect between the free end of any of the set of SMA actuators and the moving portion. The string can wrap one or more times around the moving portion.

In some instances, the moving portion comprises a spur gear, wherein the rod is disposed in a center of the spur gear, and wherein movement of the spur gear allows each SMA actuator to return to a starting position before any tooth of the spur gear moves past the free end the SMA actuators.

In another example embodiment, a device is provided. The device can include an actuator body that comprises a fixed portion configured to remain static and a moving portion configured to rotate. The device can also include a set of shape memory alloy (SMA) actuators that each include a fixed end fixed to the fixed portion of the actuator body and a free end in contact to the moving portion. Each SMA actuator can also include a shape memory alloy (SMA) material disposed between the fixed end and the free end. Each of the set of SMA actuators can be configured to, in response to an electrical current, extend or retract to enable rotation of the moving portion in a clockwise or a counter-clockwise direction.

In some instances, the device can include a rod disposed in an opening formed the actuator body along a central axis.

In some instances, the device can include a low friction centering element disposed adjacent to the rod, wherein the low friction centering element includes any of a bearing, a bushing, opposite poled magnets, and a flexure spring.

In some instances, the set of SMA actuators include a first pair of SMA actuators disposed on a first side of the actuator body and a second pair of SMA actuators disposed on a second side of the actuator body opposite the first side.

In some instances, any of the set of SMA actuators are disposed in a vertical orientation where a length of each SMA actuator is disposed substantially in parallel with the central axis or are disposed in a horizontal orientation where a length of each SMA actuator is disposed substantially perpendicular to the central axis.

In another example embodiment, a method is provided. The method can include disposing a rod in a center portion of an actuator body, wherein the actuator body comprises a static base and a moving carriage. The method can also include disposing a set of shape memory alloy (SMA) actuators to the static base, wherein each of the SMA actuators have a fixed end fixed to the static base and a free end configured to contact the moving carriage. The method can also include providing a current to any of the SMA actuators to cause clockwise or counterclockwise rotation of the moving carriage.

In some instances, two opposing SMA actuators are configured to extend and another two opposing SMA actuators are configured to retract to cause clockwise or counter-clockwise rotation of the actuator body.

In some instances, the part of the actuator body that is configured to move is disposed above the fixed portion of the actuator body in a vertical configuration.

In some instances, the method further includes adding a fluid in a housing, wherein the fluid is configured to be hermetically sealed in the housing.

According to some embodiments, the processes described herein are used to form one or more of any of mechanical structures and electro-mechanical structures.

It will be understood that terms such as “top,” “bottom,” “above,” “below,” and x-direction, y-direction, and z-direction as used herein as terms of convenience that denote the spatial relationships of parts relative to each other rather than to any specific spatial or gravitational orientation. Thus, the terms are intended to encompass an assembly of component parts regardless of whether the assembly is oriented in the particular orientation shown in the drawings and described in the specification, upside down from that orientation, or any other rotational variation.

It will be appreciated that the term “present invention” as used herein should not be construed to mean that only a single invention having a single essential element or group of elements is presented. Similarly, it will also be appreciated that the term “present invention” encompasses a number of separate innovations, which can each be considered separate inventions. Although the present invention has been described in detail with regards to the preferred embodiments and drawings thereof, it should be apparent to those skilled in the art that various adaptations and modifications of embodiments of the present invention may be accomplished without departing from the spirit and the scope of the invention. Additionally, the techniques described herein could be used to make a device having two, three, four, five, six, or more generally n number of bimorph actuators and buckle actuators. Accordingly, it is to be understood that the detailed description and the accompanying drawings as set forth hereinabove are not intended to limit the breadth of the present invention, which should be inferred only from the following claims and their appropriately construed legal equivalents.

What is claimed is:

1. A rotational actuation system comprising:
an actuator body that comprises a fixed portion configured to remain static and a moving portion configured to rotate;
a rod disposed in an opening formed the actuator body along a central axis; and
a set of shape memory alloy (SMA) actuators that each include:
a fixed end fixed to the fixed portion of the actuator body;
a free end in contact to the moving portion; and
a shape memory alloy (SMA) material disposed between the fixed end and the free end, wherein each of the set of SMA actuators are configured to, in response to an electrical current, extend or retract to enable rotation of the moving portion in a clockwise or a counter-clockwise direction.

2. The rotational actuation system of claim 1, further comprising:
a low friction centering element disposed adjacent to the rod, wherein the low friction centering element includes any of a bearing, a bushing, opposite poled magnets, and a flexure spring.

3. The rotational actuation system of claim 1, wherein the set of SMA actuators include a first pair of SMA actuators disposed on a first side of the actuator body.

4. The rotational actuation system of claim 3, wherein the set of SMA actuators include a second pair of SMA actuators disposed on a second side of the actuator body opposite the first side.

5. The rotational actuation system of claim 4, wherein the electrical current is configured to be provided to a first SMA actuator of the first pair of SMA actuators and a first SMA actuator of the second pair of SMA actuators to cause clockwise or counter-clockwise rotation of the moving portion.

6. The rotational actuation system of claim 1, wherein any of the set of SMA actuators are disposed in a vertical orientation where a length of each SMA actuator is disposed substantially in parallel with the central axis.

7. The rotational actuation system of claim 6, wherein the moving portion is disposed above the fixed portion of the actuator body in the vertical orientation.

8. The rotational actuation system of claim 1, wherein any of the set of SMA actuators are disposed in a horizontal orientation where a length of each SMA actuator is disposed substantially perpendicular to the central axis.

9. The rotational actuation system of claim 1, wherein the SMA material for each of the set of SMA actuators is connected at a first end to the fixed end of the SMA actuator and connected at a second end to the free end of the SMA actuator.

10. The rotational actuation system of claim 1, wherein the moving portion is configured to move around 20 degrees in either the clockwise or the counter-clockwise direction.

11. The rotational actuation system of claim 1, further comprising:
a housing formed in the fixed portion configured to house a fluid.

12. The rotational actuation system of claim 11, wherein the fluid is configured to be hermetically sealed in the housing, and wherein the fluid comprises any of a water/glycol mixture or a mineral oil to cool the rotational actuation system.

13. The rotational actuation system of claim 1, further comprising a return spring disposed adjacent to the moving portion to provide a torque and return the moving portion to a rotation starting point.

14. The rotational actuation system of claim 1, wherein a string is configured to connect between the free end of any of the set of SMA actuators and the moving portion.

15. The rotational actuation system of claim 1, wherein the moving portion comprises a spur gear, wherein the rod is disposed in a center of the spur gear, and wherein movement of the spur gear allows each SMA actuator to return to a starting position before any tooth of the spur gear moves past the free end the SMA actuators.

16. A device comprising:
an actuator body that comprises a fixed portion configured to remain static and a moving portion configured to rotate; and
a set of shape memory alloy (SMA) actuators that each include:
a fixed end fixed to the fixed portion of the actuator body;
a free end in contact to the moving portion; and
a shape memory alloy (SMA) material disposed between the fixed end and the free end, wherein each of the set of SMA actuators are configured to, in response to an electrical current, extend or retract to enable rotation of the moving portion in a clockwise or a counter-clockwise direction.

17. The device of claim 16, further comprising:
a rod disposed in an opening formed the actuator body along a central axis.

18. The device of claim 17, further comprising:
a low friction centering element disposed adjacent to the rod, wherein the low friction centering element includes any of a bearing, a bushing, opposite poled magnets, and a flexure spring.

19. The device of claim 16, wherein the set of SMA actuators include a first pair of SMA actuators disposed on a first side of the actuator body and a second pair of SMA actuators disposed on a second side of the actuator body opposite the first side.

20. The device of claim 17, wherein any of the set of SMA actuators are disposed in a vertical orientation where a length of each SMA actuator is disposed substantially in parallel with the central axis or are disposed in a horizontal orientation where a length of each SMA actuator is disposed substantially perpendicular to the central axis.
